(19) United States
(12) Patent Application Publication
(10) Pub. No.: US 2026/0340393 A1
(43) Pub. Date: Oct. 29, 2026

(54) MULTI-DIMENSIONAL DATA PREDICTION METHOD AND SYSTEM FOR DISCRETE MANUFACTURING WORKSHOP

(71) Applicant: NANJING UNIVERSITY OF POSTS AND TELECOMMUNICATIONS, Nanjing (CN)

(72) Inventors: Haigen YANG, Nanjing (CN); Hao DING, Nanjing (CN); Erhan DAI, Nanjing (CN); Yan GE, Nanjing (CN); Jixin LIU, Nanjing (CN); Fanyu ZENG, Nanjing (CN)

(21) Appl. No.: 19/696,544

(22) Filed: Jun. 3, 2026

Related U.S. Application Data
(63) Continuation of application No. PCT/CN2025/073898, filed on Jan. 22, 2025.

(30) Foreign Application Priority Data
Oct. 16, 2024 (CN) 202411441286.7

(51) Int. Cl. G06N 3/084; G06N 3/048; G06N 5/022

(52) U.S. Cl. CPC G06N 3/084; G06N 3/048; G06N 5/022

(57) ABSTRACT

A multi-dimensional data prediction method and system for a discrete manufacturing workshop. The method comprises the following steps: obtaining a raw data set; using a DBSCAN algorithm to perform clustering on the raw data set, so as to obtain a plurality of data clusters, and establishing corresponding labels for the data clusters; searching for association relationships between the labels, so as to constitute data knowledge; deleting redundant data from all the data knowledge, so as to form a knowledge network; obtaining raw data which is cleaned in step S1 and corresponds to labels included in the data knowledge; initializing the weight of a BP network structure, so as to obtain an initial model; obtaining a final prediction model; and acquiring raw data of discrete manufacturing to be processed, and inputting same into the prediction model, and the prediction model outputting a prediction result.

### TECHNICAL FIELD

The present disclosure relates to a data prediction method and system, and in particular to a multi-dimensional data prediction method and system for a discrete manufacturing workshop.

### BACKGROUND

Currently, most manufacturing enterprises have completed the transition from a manual management mode to an information-based management mode, thereby achieving the accumulation of massive amounts of machining, quality, equipment, personnel, and other related data generated during a manufacturing process. Faced with continuously generated high-dimensional manufacturing data, how to mine valuable information therein to provide correct guidance for daily production in the manufacturing industry, so as to reduce quality problems, energy consumption, and operating costs during manufacturing, and improve production efficiency, has become an urgent problem to be solved.

This is especially true for discrete manufacturing, which exhibits complex and diverse business scenarios, variable production processes and methods, and large volumes of data generated during production. Currently, most approaches to mining useful information directly use deep learning methods to build a neural network model for production factor prediction. However, high-dimensional data lead to redundancy in network nodes, thereby increasing computational costs.

### SUMMARY

Objectives: A first objective of the present disclosure is to provide a multi-dimensional data prediction method for a discrete manufacturing workshop that can reduce computational cost and efficiently mine valuable information.

A second objective of the present disclosure is to provide a multi-dimensional data prediction system for a discrete manufacturing workshop.

Technical solution: The present disclosure discloses a multi-dimensional data prediction method for a discrete manufacturing workshop, including the following steps:
S1, collecting raw data of discrete manufacturing and cleaning the same to obtain a raw data set, where the raw data includes product quality indicator data, equipment energy consumption indicator data, and operating cost data generated during a discrete manufacturing process;

S2, using a density-based spatial clustering of applications with noise (DBSCAN) algorithm to perform clustering on the raw data set to obtain a plurality of data clusters, and establishing corresponding labels for the data clusters;
S3, establishing a qualitative cognition, and using an Apriori algorithm to search for association relationships between the labels, where two or more labels that are associated constitute a piece of data knowledge;
S4, deleting redundant data from all the data knowledge, then extracting association relationships between various pieces of data knowledge, and constructing a knowledge network to complete the qualitative cognition;
S5, traversing each piece of data knowledge contained in the knowledge network of S4 to obtain raw data that is cleaned in S1 and corresponds to labels contained in the data knowledge, and using the cleaned raw data corresponding to the labels as a performance indicator sample;
S6, using a dual-mechanism teaching-learning-based optimization-back propagation (DMTLBO-BP) network model to construct an original back propagation (BP) network structure, and initializing a weight of the BP network structure according to the performance indicator sample to obtain an initial model;
S7, training the initial model, and updating a weight of the initial model to obtain a final prediction model; and
S8, acquiring the performance indicator sample corresponding to the raw data of discrete manufacturing to be processed, inputting the same into the prediction model, where the prediction model outputs a prediction result.

Further, the BP network structure in S6 includes one input layer, two hidden layers, and one output layer, where the number of neurons in the input layer is Nₘ, and Nₘ is equal to the total number of pieces of data knowledge obtained in S3; the number of neurons in the hidden layer 1 is Nᵢ; the number of neurons in the hidden layer 2 is Nₖ; and the number of neurons in the output layer is Nⱼ, and Nⱼ is equal to the number of conclusions derived from association of the Apriori algorithm in S3.

Further, the initializing a weight of the BP network structure according to the performance indicator sample in S6 includes the following sub-steps:
S6-1, encoding the performance indicator sample through real-number encoding to obtain an encoded array, where an encoding formula is as follows:

L=Nₘ×(Nₖ+Nᵢ)+Nⱼ×(Nₖ+Nᵢ)+(Nₖ+Nᵢ+Nⱼ);
in the formula, L represents an encoding length;
S6-2, defining the encoded array as a class population, and determining a class population size as L and the number of iterations as a;
S6-3, randomly dividing the class population into b groups, and selecting an individual with optimal fitness in each group as a teacher, where the fitness is defined as a score;
S6-4, using a difference in scores between the teacher and students in the class population to enable the teacher to impart knowledge to the students;
S6-5, calculating an average score of the b groups, and defining top half of students in each group as excellent students, and the remaining students as poor students;
S6-6, executing an excellent student self-study strategy and a poor student mutual-learning strategy;
S6-7, performing collaborative exchange optimization with in each group, selecting the top k individuals with optimal scores in the group to replace the bottom k individuals with lowest scores in the group, and repeating the operation for h iterations until a difference between a current score and a score of the previous iteration in each group is less than a predetermined value, where a calculation formula for k is as follows:

k=Gen/C;
in the formula, Gen represents a current iteration number, and C represents a constant;
S6-8, repeating S6-4 to S6-7 for a iterations; and
S6-9, searching for an individual with an optimal score in the class population, where the individual is encoded as an initial weight of the BP network structure.

Further, a calculation formula for the fitness in S6-3 is:

$$F = \frac{1}{{\sum }_{k = 1}^{{N}_{j}} {( {d}_{q} - {y}_{q} )}^{2}} ;$$

in the formula, Nⱼ represents the number of neurons in the output layer, d_{q} represents an expected output of a k^{th} neuron in the output layer, and y_{q} represents an actual output of the k^{th} neuron in the output layer.

Further, a calculation formula for the knowledge imparting in S6-4 is:

D_M=rᵢ×(M_{taecher}−TF×Mₘₑₐₙ).
in the formula, rⱼ=rand(0,1) represents a learning step size, TF=[1+rand(0,1)] represents a teaching factor, M_{taecher} represents a score of the teacher, and Mₘₑₐₙ represents a score of a current iteration;
the student approaches the teacher according to the formula D_M.

$${X}_{i , j}^{′} = {X}_{i , j} + D\_M ;$$

in the formula,

$${X}_{i , j}^{′}$$

represents a score of a student j in a generation i after teaching, and X_{i,j} represents a score of the student j in the generation i before teaching.

Further, the excellent student self-learning strategy in S6-6 refers to that the excellent students perform in-depth self-exploration N times, where a calculation formula for the number of explorations N is as follows:

$$N = round [ \frac{{F}_{max} - {F}_{i}}{{F}_{max} - {F}_{min}} ( UL - LL ) + LL ] ;$$

in the formula, Fᵢ represents a score of an i^{th} individual in the group; Fₘₐₓ represents an optimal score in the group; Fₘᵢₙ represents a lowest score in the group; UL represents an upper limit of the number of explorations, that is set according to actual conditions; and LL is a lower limit of the number of explorations, that is set according to actual conditions; and
the poor student mutual-learning strategy refers to that the poor students learn from other better individuals through inter-group mutual learning, where an individual xₚ learns from a randomly selected better individual x_{q}, and a learning formula is as follows:

$$\begin{matrix}{X}_{i , p}^{′} = {X}_{i , p} + {r}_{i} ( {X}_{i , p} - {X}_{i , q} ) , F ( {X}_{i , p} ) \leq F ( {X}_{i , q} ) ; \\ {X}_{i , p}^{′} = {X}_{i , p} + {r}_{i} ( {X}_{i , p} - {X}_{i , q} ) , F ( {X}_{i , p} ) > F ( {X}_{i , q} ) ;\end{matrix}$$

in the formula,

$${X}_{i , p}^{′}$$

represents a score of the individual xₚ after teaching, and X_{i,p} represents a score of the individual xₚ before teaching; when F(X_{i,p}) is better than F(X_{i,q}) a new individual is accepted; otherwise, an old individual is retained.

Further, the training the initial model, and updating a weight of the initial model to obtain a final prediction model in S7 includes the following sub-steps:
S7-1, calculating an input value of the hidden layer 1 of the BP network structure;
S7-2, calculating an output value of the hidden layer 1 according to the input value of the hidden layer 1;
S7-3, calculating an input value of the hidden layer 2 according to the output value of the hidden layer 1;
S7-4, calculating an output value of the hidden layer 2 according to the input value of the hidden layer 2;
S7-5, calculating an input value of the output layer according to the output value of the hidden layer 2;
S7-6, calculating an output value of the output layer according to the input value of the output layer;
S7-7, calculating a backpropagation error of the BP network structure according to the output value of the output layer;
S7-8, updating a weight value of the BP network structure according to the backpropagation error; and
S7-9, setting the number of weight value iterations of the BP network structure; when the number of iterations is not reached, repeating S7-1 to S7-8; and when the number of iterations is reached, outputting the initial model with the current weight value, where this initial model serves as the final prediction model.

Further, a calculation formula in S7-1 is as follows:

\vec{c}₂=\vec{x}×\vec{w}₂.
in the formula, \vec{x} represents a data matrix composed of performance indicator samples, and \vec{w}₂ represents a weight matrix |N̅ᵢ̅×̅N̅ₘ̅ from the input layer to the hidden layer 1;
a calculation formula in S7-2 is as follows:

\vec{a}₂=g(\vec{c}₂).
in the formula, |g̅(̅z̅)̅ represents an activation function,

$$g ( z ) = \frac{1}{1 + {e}^{- z}} ,$$

a calculation formula in S7-3 is as follows:

\vec{c}₃=\vec{w}ᵢₖ×\vec{a}₂.

in the formula, \vec{w}ᵢₖ represents a weight matrix of |N̅ₖ̅×̅N̅ᵢ̅;
a calculation formula in S7-4 is as follows:

\vec{a}₃=g[\vec{w}ᵢₖ×\vec{a}₂]=g(\vec{c}₃)
a calculation formula in S7-5 is as follows:

\vec{c}₄=\vec{w}ᵢⱼ×\vec{a}₃.
in the formula, \vec{W}ₖⱼ represents a weight matrix of |N̅ᵢ̅×̅N̅ₖ̅;
a calculation formula in S7-6 is as follows:

\vec{a}₄=g(\vec{c}₄)
the backpropagation error in S7-7 includes an output layer error and a hidden layer error, where a calculation formula for the output layer error is as follows:

\vec{δ}₄=\vec{a}₄−\vec{y}′;
in the formula, \vec{y}′ represents an actual output value matrix;
a calculation formula for the hidden layer error is as follows:

$${\vec{δ}}_{3} = {\vec{w}}_{kj}^{T} \times {\vec{δ}}_{4} ▯ {\vec{g}}^{′} ( {c}_{3} ) ;$$

in the formula,

$${W}_{kj}^{T}$$

represents a transpose of the weight matrix between the hidden layer and the output layer; and
a calculation formula for the weight value in S7-8 is as follows:

\vec{w}_{new}=\vec{w}_{old}−α[(\vec{y}−\vec{y}′)·\vec{y}′(1−\vec{y}′)·\vec{x}];
in the formula, \vec{y} represents an expected output matrix, represents an expected output matrix, \vec{x} represents an expected output matrix, \vec{w}_{old} represents a weight value of the previous iteration, and α represents a learning rate, α∈(0,1).

Based on the same inventive concept, the present disclosure further discloses a multi-dimensional data prediction system for a discrete manufacturing workshop, including:
a data processing module configured to sequentially perform cleaning, clustering, labeling, and association processing on raw data of discrete manufacturing to obtain a performance indicator sample;
a model construction module configured to use a DMTLBO-BP network model to construct an original back propagation network structure, and initialize a weight of the BP network structure according to a performance indicator sample to obtain an initial model; and
a prediction model module configured to train the initial model, and update a weight of the initial model to obtain a final prediction model.

Further, the data processing module includes:
a data input sub-module configured to acquire raw data of discrete manufacturing and clean the same to obtain a raw data set;
a clustering and classification sub-module configured to use a DBSCAN algorithm to perform clustering on the raw data set to obtain a plurality of data clusters, and establish corresponding labels for the data clusters;
a qualitative cognition sub-module configured to use an Apriori algorithm to search for association relationships between the labels, where two or more labels that are associated constitute a piece of data knowledge;
a knowledge network construction sub-module configured to delete redundant data from all the data knowledge in the qualitative cognition sub-module, then extract association relationships between various pieces of data knowledge, and construct a knowledge network; and
a data reconstruction sub-module configured to acquire cleaned raw data from the data input sub-module corresponding to the labels contained in the data knowledge of the knowledge network in the knowledge network construction sub-module, and use the raw data as the performance indicator sample.

Beneficial effects: Compared with the prior art, the present disclosure has the following significant advantages: By means of a qualitative cognition method and a quantitative and qualitative two-stage cognition method, the method solves the problems of a large data volume and large dimensions of a discrete manufacturing workshop in a divide-and-rule mode, and reduces the calculation cost. Moreover, the prediction model of the present disclosure can efficiently mine valuable information required for prediction.

### BRIEF DESCRIPTION OF THE DRAWINGS

FIG. 1 is a flowchart of a method of the present disclosure.

FIG. 2 is a flowchart of training an initial model in the present disclosure.

FIG. 3 is a structural diagram of a BP network structure in the present disclosure.

FIG. 4 is a schematic diagram of a discrete manufacturing process in the present disclosure.

FIG. 5 is a flowchart of a system of the present disclosure.

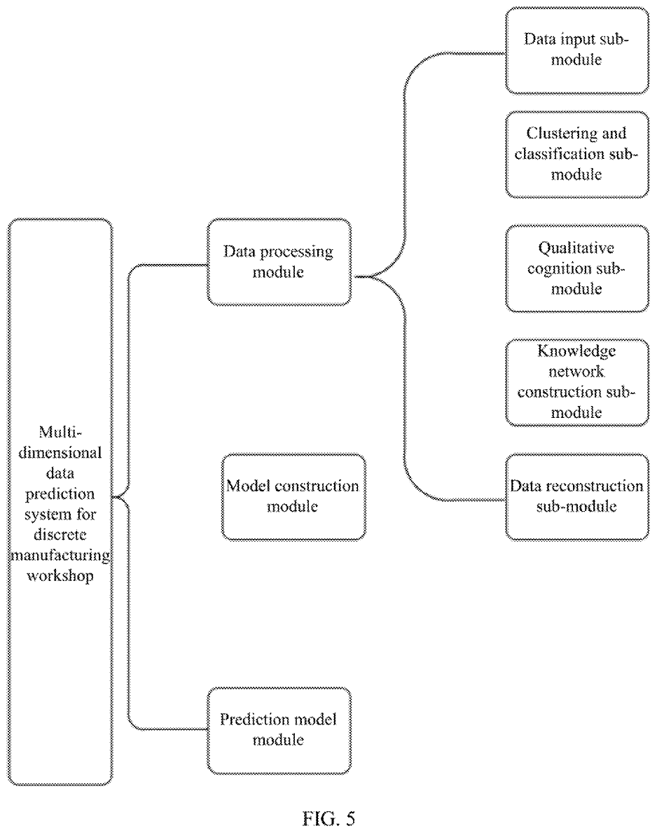

### DETAILED DESCRIPTIONS OF THE EMBODIMENTS

The technical solution of the present disclosure will be further described below in combination with the drawings.

### Embodiment 1

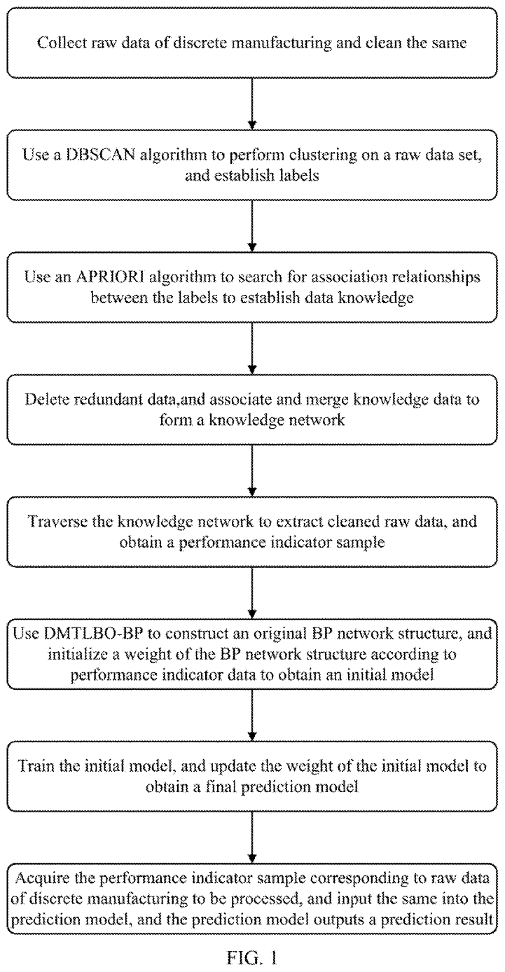

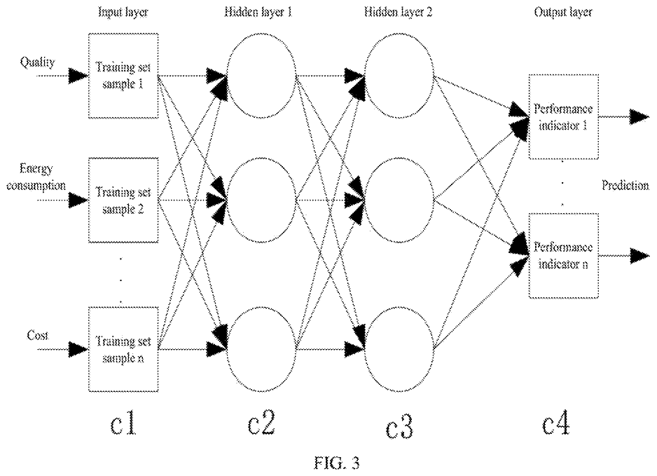

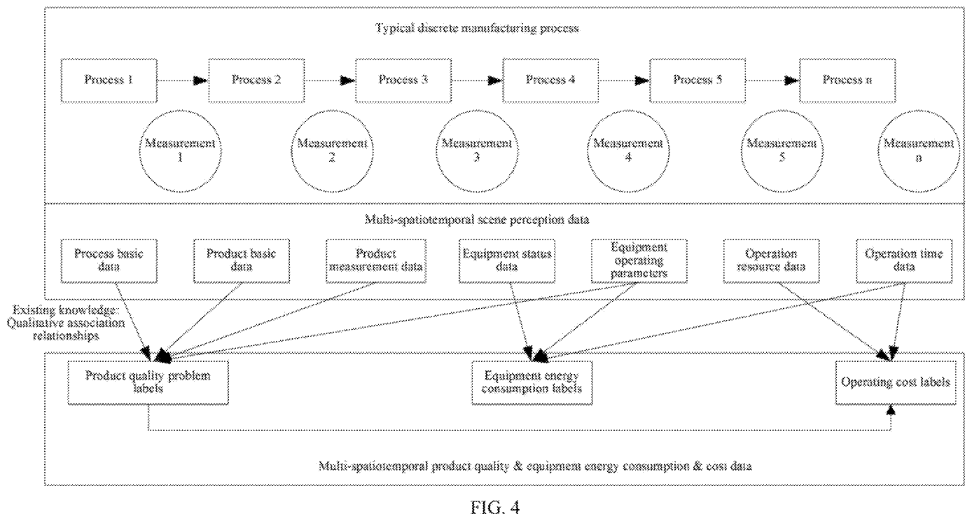

A multi-dimensional data prediction method for a discrete manufacturing workshop of the present disclosure, as shown in FIG. 1 and FIG. 3, includes the following steps:
S1, raw data of discrete manufacturing is collected and cleaned to form a raw data set, where the raw data includes product quality indicator data, equipment energy consumption indicator data, and operating cost data generated during a discrete manufacturing process. The data cleaning refers to deleting duplicate values in the raw data and filling in missing values.
S2, a DBSCAN algorithm is used to perform clustering on the raw data set to obtain a plurality of data clusters, and corresponding labels are established for the data clusters. In the raw data set containing t indicator data, a radius and a minimum number of MinPts are defined using the DBSCAN algorithm. One indicator data is randomly selected therein, and it is observed whether a neighborhood with the radius & contains the minimum number of MinPts. When the requirement is met, the indicator data is a core point; and then all corresponding indicator data are identified as a new cluster, and the cycle is continued in the same manner until all indicator data in the raw data set are processed. Equipment energy consumption indicator data is taken as an example: Equipment energy consumption data includes temperature, pressure, and the like; and similar labels are constructed, such as Equipment \textcircled{1} Temperature \textcircled{1} Pressure \textcircled{1}, Equipment \textcircled{1} Temperature \textcircled{1} Pressure \textcircled{2}, and Equipment \textcircled{1} Temperature \textcircled{2} Pressure \textcircled{1}
S3, a qualitative cognition is established, and an Apriori algorithm is used to search for association relationships between the labels, where two or more labels that are associated constitute a piece of data knowledge. As shown in FIG. 4, labels corresponding to product quality indicator data are taken as an example: Using the Apriori association algorithm, labels related to product quality indicators from S2 are scanned into a data set, a count of each item is accumulated, items that meet a minimum support are mined, and a set L1 of frequent 1-itemsets (Product 1 Measurement 1 Quality Excellent) is identified; L1 is used to identify a set L2 of frequent 2-itemsets, i.e., association rules between two different process measurements, L2 is used to identify L3, i.e., association rules among three process measurements, and so on until no further frequent n-itemsets can be identified; and a qualitative cognition is established, and a mathematical model

$${⋃}_{n} {P}_{i} \to K$$

of product quality indicator data is constructed, in the formula, Pᵢ and K respectively represent conditions and conclusions of the corresponding labels. For example,

$${⋃}_{2} {P}_{i} \to K$$

represents that the conclusion K can be derived from conditions P₁ and P₂; and for example, the conclusion that the quality of Product 1 is excellent is derived from Product 1 Measurement 1 Quality Excellent+Product 1 Measurement 2 Quality Excellent+ . . . +Product 1 Measurement n Quality Excellent.
S4, redundant data from all the data knowledge are deleted, then association relationships between various cleaned pieces of data knowledge are extracted, and a knowledge network is constructed to complete the qualitative cognition. Deleting redundant data refers to the following two situations: \textcircled{1} When there are two pieces of knowledge

$${⋃}_{n} {P}_{i} \to K and {⋃}_{m} {Q}_{j} \to K , and {⋃}_{m} {Q}_{j} ⊆ {⋃}_{n} {P}_{i}$$

is satisfied, then knowledge

$${⋃}_{n} {P}_{i} \to K$$

is considered redundant to knowledge

$${⋃}_{m} {Q}_{j} \to K , and {⋃}_{n} {P}_{i} \to K$$

is deleted. \textcircled{2}When there are two pieces of knowledge

$${⋃}_{n} {P}_{i} \to {K}_{1} and {⋃}_{n} {P}_{i} \to {K}_{2} ,$$

and K₁⊆K₂ is satisfied, then knowledge UPᵢ→K₂ is considered redundant to knowledge

$${⋃}_{n} {P}_{i} \to {K}_{1} , and {⋃}_{n} {P}_{i} \to {K}_{2}$$

is deleted.

S5, each piece of data knowledge contained in the knowledge network of S4 is traversed to obtain raw data that is cleaned in S1 and corresponds to labels contained in the data knowledge, and the cleaned raw data corresponding to the labels is used as a performance indicator sample. From this step onward, a quantitative cognition is performed on the data. By means of a qualitative cognition method and a quantitative and qualitative two-stage cognition method, the method solves the problems of a large data volume and large dimensions of a discrete manufacturing workshop in a divide-and-rule mode, reduces the calculation cost, and can efficiently mine valuable information required for prediction.

S6, a DMTLBO-BP network model is established as an original model, an original BP network structure is constructed, and a weight of the BP network structure is initialized according to the performance indicator sample to obtain an initial model. The BP network structure includes one input layer, two hidden layers, and one output layer, where the number of neurons in the input layer is Nₘ, and Nₘ is equal to the total number of pieces of data knowledge obtained in S3, i.e., Nₘ is equal to the number of feature elements of

$${⋃}_{n} {P}_{i} ;$$

the number of neurons in the hidden layer 1 is Nᵢ; the number of neurons in the hidden layer 2 is Nₖ; and the number of neurons in the output layer is Nⱼ, and Nⱼ is equal to the number of conclusions derived from association of the Apriori algorithm in S3, i.e., Nⱼ is equal to K in S4, as shown in FIG. 3.

The initializing a weight of the BP network structure according to the performance indicator sample in S6 includes the following sub-steps:
S6-1, the performance indicator sample is encoded through real-number encoding to obtain an is as encoded array. An encoding method follows:

L=Nₘ×(Nₖ+Nᵢ)+Nⱼ×(Nₖ+Nᵢ)+(Nₖ+Nᵢ+Nⱼ);
in the formula, L represents an encoding length.
S6-2, the encoded array is defined as a class population, a class population size is determined as L, and the number of iterations is determined as a. Specifically, the number of iterations a may be set according to the situation.
S6-3, the class population is randomly divided into b groups, and an individual with optimal fitness in each group is selected as a teacher, where the fitness is defined as a score. A calculation formula for the fitness is as follows:

$$F = \frac{1}{{\sum }_{k = 1}^{{N}_{j}} {( {d}_{q} - {y}_{q} )}^{2}} ;$$

in the formula, Nⱼ represents the number of neurons in the output layer, d_{q} represents an expected output of a k^{th} neuron in the output layer, and y_{q} represents an actual output of the k^{th} neuron in the output layer.
S6-4, a difference between the teacher and students in the class population is used to enable the teacher to impart knowledge to the students in the class population. A calculation formula for the knowledge imparting is as follows:

D_M=rᵢ×(M_{taecher}−TF×Mₘₑₐₙ);
in the formula, rᵢ=rand(0,1) represents a learning step size, TF=[1+rand(0,1)] represents a teaching factor, M_{taecher} represents a score of the teacher, and Mₘₑₐₙ represents a score of a current iteration;
the student approaches the teacher according to the formula

$$D\_M : {X}_{i , j}^{′} = {X}_{i , j} + D\_M ;$$

in the formula,

$${X}_{i , j}^{′}$$

represents a score of a student j in a generation i after teaching, and X_{i,j} represents a score of the student j in the generation i before teaching.
S6-5, an average score of the b groups is calculated, top half of students in each group is defined as excellent students, and the remaining students are defined as poor students.
S6-6, an excellent student self-study strategy and a poor student mutual-learning strategy are executed. The excellent student self-study strategy refers to that the excellent students perform in-depth self-exploration N times to improve their own scores, where a calculation formula for the number of explorations N is as follows:

$$N = round [ \frac{{F}_{max} - {F}_{i}}{{F}_{max} - {F}_{min}} ( UL - LL ) + LL ] ,$$

in the formula, Fᵢ represents a score of an i^{th} individual in the group; Fₘₐₓ represents an optimal score in the group; Fₘᵢₙ represents a lowest score in the group; UL represents an upper limit of the number of explorations, and UL is set according to actual conditions; and LL is a lower limit of the number of explorations, and LL is set according to actual conditions; and
the poor student mutual-learning strategy refers to that the poor students learn from other better individuals through inter-group mutual learning, where an individual xₚ learns from a randomly selected better individual x_{q}, and a learning formula is as follows:

$${X}_{i , p}^{′} = {X}_{i , p} + {r}_{i} ( {X}_{i , p} - {X}_{i , q} ) , F ( {X}_{i , p} ) \leq F ( {X}_{i , q} ) ;$$

$${X}_{i , p}^{′} = {X}_{i , p} + {r}_{i} ( {X}_{i , p} - {X}_{i , q} ) , F ( {X}_{i , p} ) > F ( {X}_{i , q} ) ;$$

in the formula,

$${X}_{i , p}^{′}$$

represents a score of the individual xₚ after teaching, and X_{i,p} represents a score of the individual xₚ before teaching; when F(X_{i,p}) is better than, a F(X_{i,q}), a new individual is accepted; otherwise, an old individual is retained.
S6-7, collaborative exchange optimization is performed with in each group, the top k individuals with optimal scores in the group are selected to replace the bottom k individuals with lowest scores in the group, and the operation is repeated for h iterations until a difference between a current score and a score of the previous iteration in each group is less than a predetermined value, i.e., the score with in each group tends to a predetermined stable state: A calculation formula for the number k of students participating in inter-group replacement exchange is as follows:

k=Gen/C.
in the formula, Gen represents a current iteration number, and C represents a constant, which can be set according to actual conditions.
S6-8, whether the number of iterations meets the condition is determined, and S6-4 to S6-7 are repeated for a iterations.
S6-9, an initial weight of the initial model is initialized, and an individual with an optimal score in the class population is searched for, where encoding of the individual serves as an initial weight of the BP network structure.
S7, the initial model is trained, and a weight of the initial model is updated to obtain a final prediction model. S7 includes the following sub-steps:
S7-1, an input value of the hidden layer 1 of the BP network structure is calculated, where a calculation formula is as follows:

\vec{c}₂=\vec{x}×\vec{w}₂;
in the formula, \vec{x} represents a data matrix composed of performance indicator samples, and \vec{w}₂ represents a weight matrix |N̅ᵢ̅×̅N̅ₘ̅ from the input layer to the hidden layer 1.
S7-2, an output value of the hidden layer 1 is calculated according to the input value of the hidden layer 1, where a calculation formula is as follows:

\vec{a}₂=g(\vec{c}₂)

$$g ( z ) = \frac{1}{1 + {e}^{- z}} .$$

in the formula, g(z) represents an activation function,
S7-3, an input value of the hidden layer 2 is calculated according to the output value of the hidden layer 1, where a calculation formula is as follows:

c₃=\vec{w}ᵢₖ×\vec{a}₂,
in the formula, \vec{w}ᵢₖ represents a weight matrix of |N̅ₖ̅×̅N̅ᵢ̅; in the formula, |N̅ᵢ̅ represents the number of neurons in the hidden layer 1, and |N̅ₖ̅ represents the number of neurons in the hidden layer 2.
S7-4, an output value of the hidden layer 2 is calculated according to the input value of the hidden layer 2, where a calculation formula is as follows:

\vec{a}₃=g[\vec{w}ᵢₖ×\vec{a}₂]=g(\vec{c}₃);
S7-5, an input value of the output layer is calculated according to the output value of the hidden layer 2, where a calculation formula is as follows:

\vec{c}₄=\vec{w}ₖⱼ×\vec{a}₃.

in the formula \vec{W}ₖⱼ, represents a weight matrix of |N̅ⱼ̅×̅N̅ₖ̅; in the formula, |N̅ⱼ̅ represents the number of neurons in the output layer, i.e., the number of label categories of prediction elements (product quality indicator data, equipment energy consumption indicator data, and operating cost data), and |N̅ₖ̅ represents the number of neurons in the hidden layer 2.
S7-6, an output value of the output layer is calculated according to the input value of the output layer, where a calculation formula is as follows:

\vec{a}₄=g(\vec{c}₄);
in the formula, |g̅(̅z̅)̅ represents an activation function.
S7-7, a backpropagation error of the BP network structure is calculated according to the output value of the output layer, where the backpropagation error includes an output layer error and a hidden layer error, and a calculation formula for the output layer error is as follows: \vec{δ}₄=\vec{a}₄−\vec{y}′,
in the formula, \vec{y}′ is represents an actual output value matrix.

A calculation formula for the hidden layer error is as follows:

$${\vec{δ}}_{3} = {\vec{w}}_{kj}^{T} \times {\vec{δ}}_{4} ▯ {\vec{g}}^{′} ( {c}_{3} ) ;$$

in the formula,

$${W}_{kj}^{T}$$

represents a transpose of the weight matrix between the hidden layer and the output layer.
S7-8, a weight value of the BP network structure is updated according to the backpropagation error, where a calculation formula is as follows:

\vec{w}_{new}=\vec{w}_{old}−α[(\vec{y}−−\vec{y}′)·\vec{y}′(1−\vec{y}′)·\vec{x}]
in the formula, \vec{y} represents an expected output matrix, represents an expected output matrix, \vec{x} represents an expected output matrix, \vec{w}_{old} represents a weight value of the previous iteration, and α represents a learning rate, α∈(0,1).
S7-9, the number of weight value iterations of the BP network structure is set; when the number of iterations is not reached, S7-1 to S7-8 are repeated; and when the number of iterations is reached, the initial model with the current weight value is output, where this initial model serves as the final prediction model.
S8, the performance indicator sample corresponding to the raw data of discrete manufacturing to be processed is acquired, and input into the prediction model, where the prediction model outputs a prediction result.

### Embodiment 2

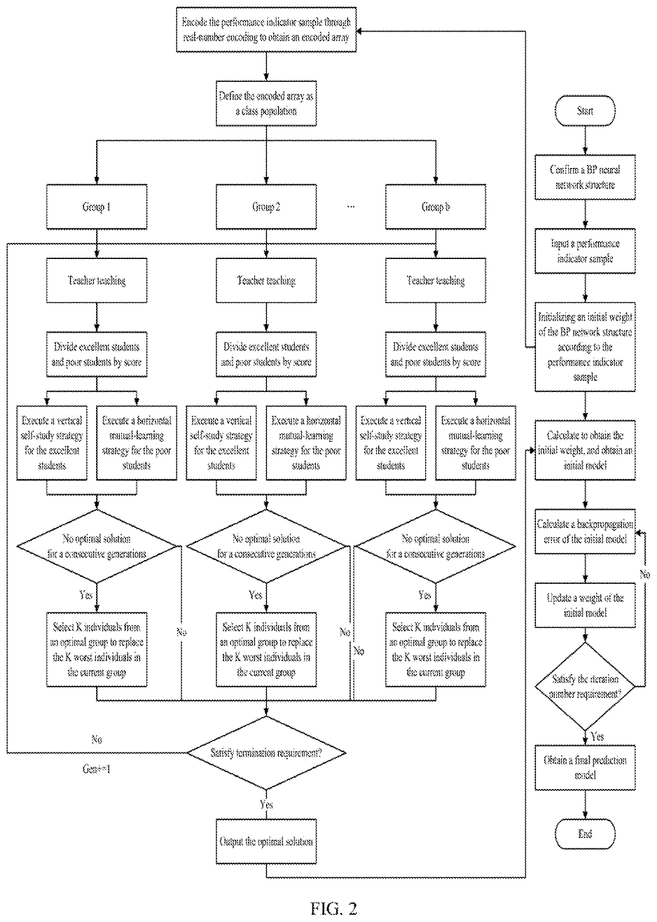

A multi-dimensional data prediction system for a discrete manufacturing workshop of the present disclosure, as shown in FIG. 2, includes a data processing module, a model construction module, and a prediction model module.

The data processing module is configured to sequentially perform cleaning, clustering, labeling, and association processing on raw data of discrete manufacturing to obtain a performance indicator sample. The data processing module includes a data input sub-module, a clustering and classification sub-module, a qualitative cognition sub-module, a knowledge network construction sub-module, and a data reconstruction sub-module.

The data input sub-module is configured to acquire raw data of discrete manufacturing and clean the same to obtain a raw data set, where the raw data includes product quality indicator data, equipment energy consumption indicator data, and operating cost data generated during a discrete manufacturing process. The data cleaning refers to deleting duplicate values in the raw data and filling in missing values.

The clustering and classification sub-module is configured to use a DBSCAN algorithm to perform clustering on the raw data set to obtain a plurality of data clusters, and establish corresponding labels for the data clusters. In the raw data set containing t indicator data, a radius and a minimum number of MinPts are defined using the DBSCAN algorithm. One indicator data is randomly selected therein, and it is observed whether a neighborhood with the radius ξ contains the minimum number of MinPts. When the requirement is met, the indicator data is a core point; and then all corresponding indicator data are identified as a new cluster, and the cycle is continued in the same manner until all indicator data in the raw data set are processed. Equipment energy consumption indicator data is taken as an example: Equipment energy consumption data includes temperature, pressure, and the like; and similar labels are constructed, such as Equipment 1 Temperature \textcircled{1} Pressure \textcircled{1}, Equipment \textcircled{1} Temperature \textcircled{1} Pressure \textcircled{2}, and Equipment Temperature \textcircled{2} Pressure \textcircled{1}.

The qualitative cognition sub-module is configured to use an Apriori algorithm to search for association relationships between the labels, where two or more labels that are associated constitute a piece of data knowledge. Labels corresponding to product quality indicator data are taken as an example: Using the Apriori association algorithm, labels in the clustering and classification sub-module related to product quality indicators are scanned into a data set, a count of each item is accumulated, items that meet a minimum support are mined, and a set L1 of frequent 1-itemsets (Product 1 Measurement 1 Quality Excellent) is identified; L1 is used to identify a set L2 of frequent 2-itemsets, i.e., association rules between two different process measurements, L2 is used to identify L3, i.e., association rules among three process measurements, and so on until no further frequent n-itemsets can be identified; and a qualitative cognition is established, and a mathematical model

$${⋃}_{n} {P}_{i} \to K$$

of product quality indicator data is constructed, in the formula, Pᵢ and K respectively represent conditions and conclusions of the corresponding labels. For example,

$${⋃}_{2} {P}_{i} \to K$$

represents that the conclusion K can be derived from conditions P₁ and P₂; and for example, the conclusion that the quality of Product 1 is excellent is derived from Product 1 Measurement 1 Quality Excellent+Product 1 Measurement 2 Quality Excellent+ . . . +Product 1 Measurement n Quality Excellent.

The knowledge network construction sub-module is configured to delete redundant data from all the data knowledge in the qualitative cognition sub-module, then extract association relationships between various pieces of data knowledge, and construct a knowledge network. Deleting redundant data refers to the following two situations: \textcircled{1} When there are two pieces of knowledge

$${⋃}_{n} {P}_{i} \to K and {⋃}_{m} {Q}_{j} \to K , and {⋃}_{m} {Q}_{j} ⊆ {⋃}_{n} {P}_{i}$$

is satisfied, then knowledge

$${⋃}_{n} {P}_{i} \to K$$

is considered redundant to knowledge

$${⋃}_{m} {Q}_{j} \to K , and {⋃}_{n} {P}_{i} \to K$$

is deleted. \textcircled{2} When there are two pieces of knowledge

$${⋃}_{n} {P}_{i} \to {K}_{1} and {⋃}_{n} {P}_{i} \to {K}_{2} ,$$

and K₁⊆K₂ is satisfied, then knowledge

$${⋃}_{n} {P}_{i} \to {K}_{2}$$

is considered redundant to knowledge

$${⋃}_{n} {P}_{i} \to {K}_{1} , and {⋃}_{n} {P}_{i} \to {K}_{2}$$

is deleted.

The data reconstruction sub-module is configured to acquire cleaned raw data from the data input sub-module corresponding to the labels contained in the data knowledge of the knowledge network in the knowledge network construction sub-module, and use the cleaned raw data corresponding to the labels as a performance indicator sample.

The model construction module is configured to use a DMTLBO-BP network model to construct an original back propagation network structure, and initialize a weight of the BP network structure according to the performance indicator sample to obtain an initial model. The BP network structure includes one input layer, two hidden layers, and one output layer, where the number of neurons in the input layer is Nₘ, and Nₘ is equal to the total number of pieces of data knowledge obtained by the qualitative cognition sub-module, i.e., Nₘ is equal to the number of feature elements of

$${⋃}_{n} {P}_{i} ;$$

the number of neurons in the hidden layer 1 is Nᵢ; the number of neurons in the hidden layer 2 is Nₖ; and the number of neurons in the output layer is Nⱼ, and Nⱼ is equal to the number of conclusions derived from association of the Apriori algorithm in the qualitative cognition sub-module, i.e., Nⱼ is equal to K in the knowledge network construction sub-module.

The performance indicator sample is encoded through real-number encoding to obtain an encoded array. An encoding method is as follows: L=Nₘ×(Nₓ+Nᵢ)+Nⱼ×(Nₖ+Nᵢ)+(Nₖ+Nᵢ+Nⱼ);
in the formula, L represents an encoding length.

The encoded array is defined as a class population, a class population size is determined as L, and the number of iterations is determined as a. Specifically, the number of iterations a may be set according to the situation.

The class population is randomly divided into b groups, and an individual with optimal fitness in each group is selected as a teacher, where the fitness is defined as a score. A calculation formula for the fitness is as follows:

$$F = \frac{1}{{\sum }_{k = 1}^{{N}_{j}} {( {d}_{q} - {y}_{q} )}^{2}} ;$$

in the formula, Nⱼ represents the number of neurons in the output layer, d_{q} represents an expected output of a k^{th} neuron in the output layer, and y_{q} represents an actual output of the k^{th} neuron in the output layer.

A difference between the teacher and students in the class population is used to enable the teacher to impart knowledge to the students in the class population. A calculation formula for the knowledge imparting is as follows:

D_M=rᵢ×(M_{taecher}−TF×Mₘₑₐₙ);
in the formula, rᵢ=r_{and}(0,1) represents a learning step size, TF=[1+rand(0,1)] represents a teaching factor, M_{taecher} represents a score of the teacher, and Mₘₑₐₙ represents a score of a current iteration;
the student approaches the teacher according to the formula

$$D\_M : {X}_{i , j}^{′} = {X}_{i , j} + D\_M ;$$

in the formula,

$${X}_{i , j}^{′}$$

represents a score of a student j in a generation i after teaching, and X_{i,j} represents a score of the student j in the generation i before teaching.

An average score of the b groups is calculated, top half of students in each group is defined as excellent students, and the remaining students are defined as poor students.

An excellent student self-study strategy and a poor student mutual-learning strategy are executed. The excellent student self-study strategy refers to that the excellent students perform in-depth self-exploration N times to improve their own scores, where a calculation formula for the number of explorations N is as follows:

$$N = round [ \frac{{F}_{max} - {F}_{i}}{{F}_{max} - {F}_{min}} ( UL - LL ) + LL ] ,$$

in the formula, Fᵢ represents a score of an i^{th} individual in the group; Fₘₐₓ represents an optimal score in the group; Fₘᵢₙ represents a lowest score in the group; UL represents an upper limit of the number of explorations, and UL is set according to actual conditions; and LL is a lower limit of the number of explorations, and LL is set according to actual conditions; and
the poor student mutual-learning strategy refers to that the poor students learn from other better individuals through inter-group mutual learning, where an individual xₚ learns from a randomly selected better individual x_{q}, and a learning formula is as follows:

$${X}_{i , p}^{′} = {X}_{i , p} + {r}_{i} ( {X}_{i , p} - {X}_{i , q} ) , F ( {X}_{i , p} ) \leq F ( {X}_{i , q} ) ;$$

$${X}_{i , p}^{′} = {X}_{i , p} + {r}_{i} ( {X}_{i , p} - {X}_{i , q} ) , F ( {X}_{i , p} ) > F ( {X}_{i , q} ) ;$$

in the formula,

$${X}_{i , p}^{′}$$

represents a score of the individual xₚ after teaching, and X_{i,p} represents a score of the individual xₚ before teaching; when F(X_{i,p}) is better than F(X_{i,g}), a new individual is accepted; otherwise, an old individual is retained.

Collaborative exchange optimization is performed with in each group, the top k individuals with optimal scores in the group are selected to replace the bottom k individuals with lowest scores in the group, and the operation is repeated for h iterations until a difference between a current score and a score of the previous iteration in each group is less than a predetermined value, i.e., the score with in each group tends to a predetermined stable state: A calculation formula for the number k of students participating in inter-group replacement exchange is as follows:

k=Gen/C
in the formula, Gen represents a current iteration number, and C represents a constant, which can be set according to actual conditions.

Whether the number of iterations meets the condition is determined, and the iteration is repeated until a iterations are completed.

An initial weight of the initial model is initialized, and an individual with an optimal score in the class population is searched for, where encoding of the individual serves as an initial weight of the BP network structure.

The prediction model module is configured to train the initial model, and update a weight of the initial model to obtain a final prediction model.

An input value of the hidden layer 1 of the BP network structure is calculated, where a calculation formula is as follows:
in the formula, \vec{x} represents a data matrix composed of performance indicator samples, and \vec{w}₂ represents a weight matrix |N̅ᵢ̅×̅N̅ₘ̅ from the input layer to the hidden layer 1.

An output value of the hidden layer 1 is calculated according to the input value of the hidden layer 1, where a calculation formula is as follows:

ä₂=g(\vec{c}₂)
in the formula, |g̅(̅z̅)̅ represents an activation function,

$$g ( z ) = \frac{1}{1 + {e}^{- z}} .$$

An input value of the hidden layer 2 is calculated according to the output value of the hidden layer 1, where a calculation formula is as follows:

\vec{c}₃=\vec{w}ᵢₖ×\vec{a}₂,

in the formula, \vec{w}ᵢₖ represents a weight matrix of |N̅ₖ̅×̅N̅ᵢ̅, where |\vec{Nⱼ} represents the number of neurons in the hidden layer 1, and |\vec{Nₖ} represents the number of neurons in the hidden layer 2.

An output value of the hidden layer 2 is calculated according to the input value of the hidden layer 2, where a calculation formula is as follows:

\vec{a}₃=g[\vec{w}ᵢₖ×\vec{a}₂]=g(\vec{c}₃).

An input value of the output layer is calculated according to the output value of the hidden layer 2, where a calculation formula is as follows:

\vec{c}₄=\vec{w}ₖᵢ×\vec{a}₃.
in the formula, \vec{W}ₖⱼ represents a weight matrix of |N̅ⱼ̅×̅N̅ₖ̅; in the formula, |N̅ⱼ̅ represents the number of neurons in the output layer, i.e., the number of label categories of prediction elements (product quality indicator data, equipment energy consumption indicator data, and operating cost data), and |N̅ₖ̅ represents the number of neurons in the hidden layer 2.

An output value of the output layer is calculated according to the input value of the output layer, where a calculation formula is as follows:

a₄=g(\vec{c}₄);

in the formula, |g̅(̅z̅)̅ represents an activation function.

A backpropagation error of the BP network structure is calculated according to the output value of the output layer, where the backpropagation error includes an output layer error and a hidden layer error, and a calculation formula for the output layer error is as follows:

\vec{δ}₄=\vec{a}₄−\vec{y}′,

in the formula, \vec{y}′ represents an actual output value matrix.

A calculation formula for the hidden layer error is as follows:

$${\vec{δ}}_{3} = {\vec{w}}_{kj}^{T} \times {\vec{δ}}_{4} ▯ {\vec{g}}^{′} ( {c}_{3} ) ;$$

in the formula,

$${W}_{kj}^{T}$$

represents a transpose of the weight matrix between the hidden layer and the output layer.

A weight value of the BP network structure is updated according to the backpropagation error, where a calculation formula is as follows:

\vec{w}_{new}=\vec{w}_{old}−α[(\vec{y}−\vec{y}′)·\vec{y}′(1−\vec{y}′)·\vec{x}];

in the formula, \vec{y} represents an expected output matrix, \vec{y}′ represents an expected output matrix, \vec{x} represents an expected output matrix, \vec{w}_{old} represents a weight value of the previous iteration, and α represents a learning rate, α∈(0,1).

The number of weight value iterations of the BP network structure is set. After the number of iterations is reached, the initial model with the current weight value is output, and this initial model serves as the final prediction model.

When the multi-dimensional data prediction system for a discrete manufacturing workshop is used, the raw data of discrete manufacturing to be processed is input into the data processing module to obtain the corresponding performance indicator sample. The performance indicator sample is input as input data into the prediction module, and the prediction module outputs a prediction result.

1. A multi-dimensional data prediction method for a discrete manufacturing workshop, comprising:
S1, collecting raw data of discrete manufacturing and cleaning the raw data to obtain a raw data set, wherein the raw data comprises product quality indicator data, equipment energy consumption indicator data, and operating cost data generated during a discrete manufacturing process;
S2, applying a density-based spatial clustering of applications with noise (DBSCAN) algorithm to the raw data set to obtain a plurality of data clusters, and establishing corresponding labels for the plurality of data clusters;
S3, establishing qualitative cognition by using an Apriori algorithm to search for association relationships between the labels, wherein two or more labels having an association relationship constitute a piece of data knowledge;
S4, deleting redundant data knowledge from the pieces of data knowledge, extracting association relationships between remaining pieces of data knowledge, and constructing a knowledge network;
S5, traversing each piece of data knowledge contained in the knowledge network to obtain cleaned raw data corresponding to labels contained in the piece of data knowledge, and using the cleaned raw data corresponding to the labels as a performance indicator sample;
S6, using a dual-mechanism teaching-learning-based optimization-back propagation (DMTLBO-BP) network model to construct an original back propagation (BP) network structure, and initializing a weight of the BP network structure according to the performance indicator sample to obtain an initial model,
wherein the BP network structure comprises one input layer, a first hidden layer, a second hidden layer, and one output layer, wherein a number of neurons in the input layer is Nm, Nm being equal to a total number of pieces of data knowledge obtained in S3, a number of neurons in the first hidden layer is Ni, a number of neurons in the second hidden layer is Nk, and a number of neurons in the output layer is Nj, Nj being equal to a number of conclusions derived from association by the Apriori algorithm in S3,
wherein initializing the weight of the BP network structure comprises:
S6-1, encoding the performance indicator sample through real-number encoding to obtain an encoded array, wherein an encoding length L is calculated according to:
L=Nₘ×(Nₖ+Nᵢ)+Nⱼ×(Nₖ+Nᵢ)+(Nₖ+Nᵢ+Nⱼ);
S6-2, defining the encoded array as a class population, and determining a class population size as L and a number of iterations as a;
S6-3, randomly dividing the class population into b groups, and selecting an individual having an optimal fitness in each group as a teacher, wherein the fitness is defined as a score and is calculated according to:
$$F = \frac{1}{{\sum }_{k = 1}^{{N}_{j}} {( {d}_{q} - {y}_{q} )}^{2}} ;$$
wherein Nⱼ represents the number of neurons in the output layer, d_{q} represents an expected output of a k^{th} neuron in the output layer, and y_{q} represents an actual output of the k^{th} neuron in the output layer;
S6-4, causing the teacher to impart knowledge to students in the class population based on a difference in scores between the teacher and the students, wherein knowledge imparting is calculated according to:
D_M=rᵢ×(M_{taecher}−TF×Mₘₑₐₙ);
wherein rᵢ=rand(0,1) represents a learning step size, TF=[1+rand(0,1)] represents a teaching factor, M_{taecher} represents a score of the teacher, and Mₘₑₐₙ represents a score of a current iteration;
and wherein a student approaches the teacher according to:
$${X}_{i , j}^{′} = {X}_{i , j} + D\_M ,$$
wherein
$${X}_{i , j}^{′}$$
represents a score of a student j in a generation i after teaching, and X_{i,j} represents a score of the student j in the generation i before teaching;
S6-5, calculating an average score of the b groups, defining a top half of students in each group as excellent students, and defining remaining students in each group as poor students;
S6-6, executing an excellent student self-study strategy and a poor student mutual-learning strategy,
wherein the excellent student self-study strategy comprises causing the excellent students to perform in-depth self-exploration N times, wherein N is calculated according to:
$$N = round [ \frac{{F}_{max} - {F}_{i}}{{F}_{max} - {F}_{min}} ( UL - LL ) + LL ] ;$$
wherein Fᵢ represents a score of an i^{th} individual in the group; Fₘₐₓ represents an optimal score in the group; Fₘᵢₙ represents a lowest score in the group; UL represents an upper limit of the number of explorations, and LL represents a lower limit of the number of explorations,
and wherein the poor student mutual-learning strategy comprises causing a poor student individual xp to learn from a randomly selected better individual xq through inter-group mutual learning according to:
$${X}_{i , p}^{′} = {X}_{i , p} + {r}_{i} ( {X}_{i , p} - {X}_{i , q} ) , F ( {X}_{i , p} ) \leq F ( {X}_{i , q} ) ,$$
$$and$$
$${X}_{i , p}^{′} = {X}_{i , p} + {r}_{i} ( {X}_{i , p} - {X}_{i , q} ) , F ( {X}_{i , p} ) > F ( {X}_{i , q} ) ,$$
wherein
$${X}_{i , p}^{′}$$
represents a score of the individual xₚ after teaching, X_{i,p} represents a score of the individual xₚ before teaching, and a new individual is accepted when the new individual is better than an old individual, otherwise the old individual is retained;
S6-7, performing collaborative exchange optimization with in each group by selecting top k individuals having optimal scores in the group to replace bottom k individuals having lowest scores in the group, and repeating the collaborative exchange optimization for h iterations until a difference between a current score and a score of a previous iteration in each group is less than a predetermined value, wherein k is calculated according to:
k=Gen/C;
wherein Gen represents a current iteration number and C represents a constant;
S6-8, repeating S6-4 to S6-7 for a iterations; and
S6-9, searching for an individual having an optimal score in the class population, wherein encoding of the individual having the optimal score serves as an initial weight of the BP network structure;
S7, training the initial model and updating the weight of the initial model to obtain a final prediction model, wherein training the initial model comprises:
S7-1, calculating an input value of the first hidden layer of the BP network structure according to:
\vec{c}₂=\vec{x}×\vec{w}₂;
wherein \vec{x} represents a data matrix composed of performance indicator samples, and \vec{w}₂ represents a weight matrix Nᵢ×Nₘ from the input layer to the hidden layer 1;
S7-2, calculating an output value of the first hidden layer according to the input value of the first hidden layer according to:
\vec{a}₂=g(\vec{c}₂);
$$g ( z ) = \frac{1}{1 + {e}^{- z}} ;$$
wherein g(z) represents an activation function,
S7-3, calculating an input value of the second hidden layer according to the output value of the first hidden layer according to:
\vec{c}₃=\vec{w}ᵢₖ×\vec{a}₂,
wherein \vec{w}ᵢₖ represents a weight matrix of Nₖ×Nᵢ;
S7-4, calculating an output value of the second hidden layer according to the input value of the second hidden layer according to:
\vec{a}₃=g[\vec{w}ᵢₖ×\vec{a}₂]=g(\vec{c}₃);
S7-5, calculating an input value of the output layer according to the output value of the second hidden layer according to:
\vec{C}₄=\vec{w}ₖⱼ×\vec{a}₃,
wherein \vec{w}ₖⱼ represents a weight matrix of Nⱼ×Nₖ;
S7-6, calculating an output value of the output layer according to the input value of the output layer according to:
\vec{a}₄=g(\vec{c}₄);
S7-7, calculating a backpropagation error of the BP network structure according to the output value of the output layer, wherein the backpropagation error comprises an output layer error and a hidden layer error,
wherein the output layer error is calculated according to:
\vec{δ}₄=\vec{a}₄−\vec{y}′;
wherein \vec{y}′ represents an actual output value matrix,
and wherein the hidden layer error is calculated according to:
$${\vec{δ}}_{3} = {\vec{w}}_{kj}^{T} \times {\vec{δ}}_{4} \cdot {\vec{g}}^{′} ( {c}_{3} ) ;$$
wherein
$${\vec{w}}_{kj}^{T}$$
represents a transpose of the weight matrix between the hidden layer and the output layer;
S7-8, updating a weight value of the BP network structure according to the backpropagation error according to:
\vec{w}_{new}=\vec{w}_{old}−α[(\vec{y}−\vec{y}′)·\vec{y}′(1−\vec{y}′)·\vec{x}];
wherein \vec{y} represents an expected output matrix, \vec{y}′ represents an expected output matrix, \vec{x} represents an expected output matrix, \vec{w}_{old} represents a weight value of the previous iteration, and α represents a learning rate, α∈(0,1);
S7-9, setting the number of weight value iterations of the BP network structure; when the number of iterations is not reached, repeating S7-1 to S7-8; and when the number of iterations is reached, outputting the initial model with the current weight value, wherein this initial model serves as the final prediction model; and
S8, acquiring raw data of discrete manufacturing to be processed, obtaining a corresponding performance indicator sample based on the raw data of discrete manufacturing to be processed, inputting the corresponding performance indicator sample into the final prediction model, and outputting, by the final prediction model, a prediction result.

2. A multi-dimensional data prediction system for a discrete manufacturing workshop, comprising:
a data processing module configured to sequentially perform cleaning, clustering, labeling, and association processing on raw data of discrete manufacturing to obtain a performance indicator sample; and
a model construction module configured to use a DMTLBO-BP network model to construct an original BP network structure, initialize a weight of the BP network structure according to the performance indicator sample to obtain an initial model,
wherein the data processing module comprises:
a data input sub-module configured to acquire the raw data of discrete manufacturing and clean the raw data to obtain a raw data set;
a clustering and classification sub-module configured to apply a density-based spatial clustering of applications with noise (DBSCAN) algorithm to the raw data set to obtain a plurality of data clusters, and establish corresponding labels for the plurality of data clusters;
a qualitative cognition sub-module configured to use an Apriori algorithm to search for association relationships between the labels, wherein two or more labels having an association relationship constitute a piece of data knowledge;
a knowledge network construction sub-module configured to delete redundant data knowledge from pieces of data knowledge generated by the qualitative cognition sub-module, extract association relationships between remaining pieces of data knowledge, and construct a knowledge network; and
a data reconstruction sub-module configured to acquire cleaned raw data from the data input sub-module corresponding to labels contained in each piece of data knowledge of the knowledge network, and use the cleaned raw data corresponding to the labels as the performance indicator sample,
wherein the BP network structure comprises one input layer, a first hidden layer, a second hidden layer, and one output layer, wherein a number of neurons in the input layer is Nₘ, Nₘ being equal to a total number of pieces of data knowledge obtained by the qualitative cognition sub-module, a number of neurons in the first hidden layer is Nᵢ, a number of neurons in the second hidden layer is Nₖ, and a number of neurons in the output layer is Nⱼ, Nⱼ being equal to a number of conclusions derived from association by the Apriori algorithm,
wherein initializing the weight of the BP network structure according to the performance indicator sample to obtain the initial model comprises:
I-1, encoding the performance indicator sample through real-number encoding to obtain an encoded array, wherein an encoding length L is calculated according to:
L=Nₘ×(Nₖ+Nᵢ)+Nⱼ×(Nₖ+Nᵢ)+(Nₖ+Nᵢ+Nⱼ);
wherein L represents an encoding length;
I-2, defining the encoded array as a class population, and determining a class population size as L and the number of iterations as a;
I-3, randomly dividing the class population into b groups, and selecting an individual with optimal fitness in each group as a teacher, wherein the fitness is defined as a score and is calculated according to:
$$F = \frac{1}{{\sum }_{k = 1}^{{N}_{j}} {( {d}_{q} - {y}_{q} )}^{2}} ;$$
wherein Nⱼ represents the number of neurons in the output layer, d_{q} represents an expected output of a k^{th} neuron in the output layer, and y_{q} represents an actual output of the k^{th} neuron in the output layer;
I-4, causing the teacher to impart knowledge to students in the class population based on a difference in scores between the teacher and the students, wherein knowledge imparting is calculated according to:
D_M=rᵢ×(M_{taecher}−TF×Mₘₑₐₙ);
wherein rᵢ=rand(0,1) represents a learning step size,TF=[1+rand(0,1)] represents a teaching factor, M_{taecher} represents a score of the teacher, and Mₘₑₐₙ represents the score of a current iteration;
and wherein a student approaches the teacher according to D_M:
$${X}_{i , j}^{′} = {X}_{i , j} + D\_M ;$$
wherein
$${X}_{i , j}^{′}$$
represents a score of a student j in a generation i after teaching, and X_{i,j} represents a score of the student j in the generation i before teaching;
I-5, calculating an average score of the b groups, defining a top half of students in each group as excellent students, and defining remaining students in each group as poor students;
I-6, executing an excellent student self-study strategy and a poor student mutual-learning strategy,
wherein the excellent student self-study strategy comprises causing the excellent students to perform in-depth self-exploration N times, wherein N is calculated according to:
$$N = round [ \frac{{F}_{max} - {F}_{i}}{{F}_{max} - {F}_{min}} ( UL - LL ) + LL ] ;$$
wherein Fᵢ represents a score of an i^{th} individual in the group; Fₘₐₓ represents an optimal score in the group; Fₘᵢₙ represents a lowest score in the group; UL represents an upper limit of a number of explorations, and LL represents a lower limit of the number of explorations,
and wherein the poor student mutual-learning strategy comprises causing a poor student individual xₚ to learn from a randomly selected better individual x_{q} through inter-group mutual learning according to:
$${X}_{i , p}^{′} = {X}_{i , p} + {r}_{i} ( {X}_{i , p} - {X}_{i , q} ) , F ( {X}_{i , p} ) \leq F ( {X}_{i , q} ) ;$$
$$and$$
$${X}_{i , p}^{′} = {X}_{i , p} + {r}_{i} ( {X}_{i , p} - {X}_{i , q} ) , F ( {X}_{i , p} ) > F ( {X}_{i , q} ) ;$$
wherein
$${X}_{i , p}^{′}$$
represents a score of the individual xₚ after teaching, and X_{i,p} represents a score of the individual xₚ before teaching; when F(X_{i,p}) is better than F(X_{i,q}), a new individual is accepted; otherwise, an old individual is retained;
I-7, performing collaborative exchange optimization with in each group by selecting top k individuals having optimal scores in the group to replace bottom k individuals having lowest scores in the group, and repeating the collaborative exchange optimization for h iterations until a difference between a current score and a score of a previous iteration in each group is less than a predetermined value, wherein k is calculated according to:
k=Gen/C,
wherein Gen represents a current iteration number, and C represents a constant;
I-8, repeating I-4 to I-7 for a iterations; and
I-9, searching for an individual having an optimal score in the class population, wherein encoding of the individual having the optimal score serves as an initial weight of the BP network structure,
wherein obtaining a final prediction model comprises:
II-1, calculating an input value of the first hidden layer of the BP network structure according to:
\vec{c}₂=\vec{x}×\vec{w}₂;
wherein \vec{x} represents a data matrix composed of performance indicator samples, and \vec{w}₂ represents a weight matrix Nᵢ×Nₘ from the input layer to the hidden layer 1;
II-2, calculating an output value of the first hidden layer according to the input value of the first hidden layer according to:
\vec{a}₂=g(\vec{c}₂),
wherein g(z) represents an activation function,
$$g ( z ) = \frac{1}{1 + {e}^{- z}} ;$$
II-3, calculating an input value of the second hidden layer according to the output value of the first hidden layer according to:
\vec{c}₃=\vec{w}ᵢₖ×\vec{a}₂,
wherein \vec{w}ᵢₖ represents a weight matrix of Nₖ×Nᵢ;
II-4, calculating an output value of the second hidden layer according to the input value of the second hidden layer according to:
\vec{a}₃=g[\vec{w}ᵢₖ×\vec{a}₂]=g(\vec{c}₃;
II-5, calculating an input value of the output layer according to the output value of the second hidden layer according to:
\vec{c}₄=\vec{w}ₖⱼ×\vec{a}₃,
wherein \vec{w}ₖⱼ represents a weight matrix of Nⱼ×Nₖ;
II-6, calculating an output value of the output layer according to the input value of the output layer according to:
\vec{a}₄=g(\vec{c}₄;
II-7, calculating a backpropagation error of the BP network structure according to the output value of the output layer, wherein the backpropagation error comprises an output layer error and a hidden layer error,
wherein the output layer error is calculated according to:
\vec{δ}₄=\vec{a}₄−\vec{y}′;
wherein \vec{y}′ represents an actual output value matrix;
and wherein the hidden layer error is calculated according to:
$${\vec{δ}}_{3} = {\vec{w}}_{kj}^{T} \times {\vec{δ}}_{4} \cdot {\vec{g}}^{′} ( {c}_{3} ) ;$$
wherein
$${\vec{w}}_{kj}^{T}$$
represents a transpose of the weight matrix between the hidden layer and the output layer;
II-8, updating a weight value of the BP network structure according to the backpropagation error according to:
\vec{w}_{new}=\vec{w}_{old}−α[(\vec{y}−\vec{y}′)·\vec{y}′(1−\vec{y}′)·\vec{x}];
wherein \vec{y} represents an expected output matrix, \vec{y}′ represents an expected output matrix, x represents an expected output matrix, \vec{w}_{old} represents a weight value of the previous iteration, and α represents a learning rate, α∈(0,1); and
II-9, setting a number of weight value iterations of the BP network structure, repeating II-1 to II-8 when the number of weight value iterations is not reached, and outputting the initial model with a current weight value as the final prediction model when the number of weight value iterations is reached.
